(19) United States
(12) Patent Application Publication
(10) Pub. No.: US 2010/0287284 A1
(43) Pub. Date: Nov. 11, 2010

(54) METHOD FOR SETTING UP APPLICATIONS BY INTERCEPTION ON AN EXISTING NETWORK

(75) Inventors: Rémy Nonnenmacher, Forges Les Bains (FR); Serge Cuesta, Rueil Malmaison (FR)

Correspondence Address: BROWDY AND NEIMARK, P.L.L.C.;624 NINTH STREET, NW, SUITE 300, WASHINGTON, DC, 20001-5303, US

(73) Assignee: ACTIVNETWORKS, LES ULIS CEDEX (FR)

(21) Appl. No.: 12/161,689

(22) PCT Filed: Jan. 16, 2007
(86) PCT No.: PCT/FR07/00075

§ 371 Date: Jul. 21, 2008

(30) Foreign Application Priority Data
Jan. 19, 2006 (FR) 0600602

(51) Int. Cl. G06F 15/16

(52) U.S. Cl. 709/227

(57) ABSTRACT

The invention concerns a method for extending applications in an existing network by intercepting communications between a client application (C) and a server application (S). It includes fixing a device (B) in a point of interception (I) of a communication line (L), which is known to support all the packet exchanges between the client (C) and the server (S) applications and enabling a connection termination point to be created on the new application (N) emulating the network identity of the application originally requested by the client application (C).

This invention relates to a method for setting up applications by interception on an existing network.

More specifically, its subject matter is the setting up of applications in an existing network by interception of communications between a customer application and a server application.

It is known that current networks generally use an application operating model based on the following steps:

1. Establishing the network address of the server application by the customer application. Quite often and in the following description, this application network address will be expressed according to the protocol used (IP address of the computer(s) supporting the application and IP port number, for example IP meaning Internet protocol).

2. Opening a communication characterised by the network address of the customer application (for IP, the IP address of the customer computer and a local port number) and the network address of the server application established in step 1.

3. Data exchange between the applications within the communication, wherein this exchange may comprise identification procedures that are more or less strict and are potentially based on the network addresses.

4. Closing the communication between the two server and customer applications, wherein this occurs at the initiative of either one and may or may not be joint.

When a new application is introduced into an existing network, a new application should be implemented, either by replacing the old application by the new one, by attributing the same network address to it, or by installing it at another address on the same computer(s) or on different computer(s).

After installation, one must intervene at step 1 described above in order to modify the network address so that the customer application connects to the new application.

The introduction of a new application according to the previously described mode especially has the following disadvantages:
the necessity to modify the establishment (step 1, above) of the network address of the new application (by modifying a domain name server, for example) or on each computer supporting the customer application.
the necessity, for the new application, to access the former application in proxy server mode, thus losing the real network identity of the customer application.
the impossibility to use the former application in the event of the new application failing without having to make the opposite address changes to revert back to the former establishment (step 1) of the address.

In all cases, the use of the new application requires modification of the architecture and the intervention of personnel specialised in several non-connected domains. Indeed apart from the purely network aspects of implementing the new application, the former application may need to be modified to indicate the presence of a proxy server mode (if it is to be used by the new application) and update the authentications based on the network addresses.

Furthermore, this personnel must remain available during all the validation phase so that they may intervene rapidly to restore the former configuration of the services in the event of the new application failing.

Another problem to be overcome is that the introduction of the proxy server mode of the new application by modifying the network address of the former application (usually via a DMS) means that the link with all of the other server applications using the same network address must be recreated.

Consequently, the situation often arises where several applications and not just a single one have to be dealt with in proxy server mode, as the application shares part of a network addressing system (the same IP address for example).

Therefore the more specific purpose of the invention is to overcome these disadvantages by inserting the new application in the system without modifying the establishment step, by the customer application of the network address of the server application, and therefore without modifying the network address of the former application.

For this purpose, the invention proposes a setting up method in an existing application network of the above mentioned type, by interception of communications between a customer application and server application at an interception point of the line that is known to support all of the packet exchanges between the two applications, with the creation of a connection termination point on the new application by an item of equipment, fitted so that it physically cuts the line and so that it imitates the network identity of the application originally demanded.

The new application may be based on the former server application to provide the desired service, possibly by imitating the network identity of the customer application.

As concerns the solutions in the prior art, the method according to the invention thus provides the following advantages:
no general modification (of the DNS, for example) or specific (station by station) modification is necessary to change the establishment of the server application address.
the new application may access the former server application by imitating the network identity of the customer application. The former server application will continue to receive the communications as if they were coming from the customer application.
in the event of failure of the new application, the former application will automatically receive the communications without any need to intervene or modify the configuration.
an accurate selection is possible so that only the communications of the desired server application are taken into account.

The method allows a very accurate control of the customer application identities, whether or not they have access to the server applications, and may therefore be used to authorise or deny access, as well as to test the new application on a small number of customer applications before general setting up.

The method allows a new application to be set up frontally with respect to a pre-existing application located at another address.

The method allows several new applications to be set up, instead of and in place of the former application and to direct the customer applications to the new server applications.

The method may be used to intervene on a communication flow more or less visibly, for any operations consisting of deleting, adding, modifying or tracing data in a communication flow between two applications.

One embodiment of the method according to the invention will be described below, by way of non-restrictive example, in reference to the appended drawings in which:

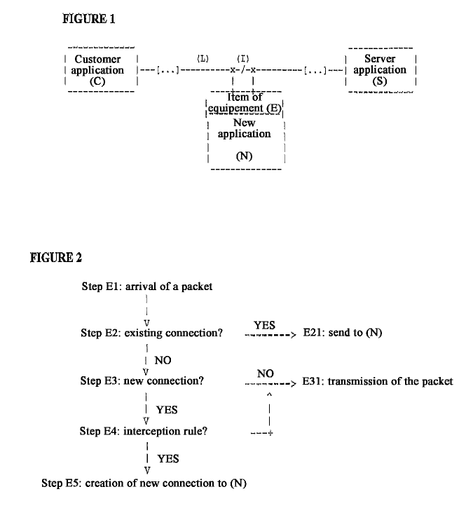

FIG. 1 is a diagrammatical representation showing an item of equipment E positioned at a physical section of a line which supports the exchanges of data packets between a customer application and a server application;

FIG. 2 is a diagrammatical representation of an organisation chart of the operations run by the item of equipment E.

In the example illustrated in FIG. 1, the method involves the intervention of an item of equipment E fitted so that it cuts a communication line L through which all of the packets run between a customer application C and a server application S.

The item of equipment E comprises at least two network communication ports compatible with the items of Equipment connected to the two ends of the line L, where it is cut, on which is positioned (for example, two Ethernet network ports if the item of equipment is designed to be placed in an Ethernet network or two BRI ports if the item of equipment is designed for a special line).

The two network ports may be equipped with a relay device that is capable of physically reconnecting each wire of the communication line in the event of a power cut to the item of equipment E or to the command (either deliberately or by a watchdog application).

The item of equipment E receives all of the packets exchanged on the communication line and identifies the packet at the start of the communication between the customer application C and the server application S.

In line with the pre-established rules, it allows the communication to proceed to the server application S or it creates a protocol termination point whose destination is the new application N. The latter therefore is viewed by the customer application C as the server application S as it appears to use the same network address.

All of the packets that are not concerned by an interception to be made or already in place between an item of equipment E and the customer C or server S applications go through without being modified between the interfaces, given that this function is similar to that of a bridge (switch or crossbar) and that optimisations (such as learning trees) may then be used.

Before the decision to intercept is made, the item of equipment E checks the operation of the new application N and in the event of the latter failing or not being available, it may allow the communication to go through without intervening, thus allowing the customer application C to connect to the server application S immediately without delay, as if the item of equipment E did not exist.

The application N may be incorporated into the item of equipment E or be accessible on one or more computers connected to the item of equipment E via any communication tunnel or protocol. Similarly, the item of equipment E may support several new applications operating concurrently and running on intercepting communications destined for other server applications.

Upon request from the new application N, the item of equipment E may open a communication with the former application S by taking on the identity of the customer application C, i.e. by using the source network address of the customer application C. In this way, the communication appears, to the server application S, to proceed from the customer application C and not from the new application N. Symmetrically, the customer application C appears and is viewed as being connected to the server application S and not to the new application N. This specific aspect preserves the authentications based on the network addresses of the customer and server applications and minimises the visibility and detectibility of the new application N. This compels the method to be inter-operable.

Of course, this opening of the communication may be made in the name of the new application itself by using a network address which belongs to the item of equipment E.

Upon request from the new application N, and if the latter has two communications open, one with the customer application C and the other with the server application S, it may drop the two communications to the item of equipment E so that the latter bridges the terminations.

Consequently, the application N may monitor the start of a communication then allow it to continue unmonitored and without introducing processing times.

Other items of equipment of the same type as E may be placed in series and downstream in order to intercept the communications that are not handled by the item of equipment E. This layout allows a duplication of the item of equipment E in the event of failure, or to distribute the work load between several items of equipment placed in series thanks to statistical decision laws, on the items of equipment, as to whether to intercept a communication or not.

The item of equipment E may be specific or created or from an existing computer equipped with at least two network ports that are compatible with the physical line L cut in order to insert the item of equipment.

It may also be made up of an electronic communication board inserted into an existing computer or item of network equipment.

Subsequently, after installation of the new applications on the item of equipment or the establishment of the connections required between the item of equipment and the computer(s) supporting the new application(s), the item of equipment is introduced and generically runs the operations described in FIG. 2.

The steps are as follows:
Step E1: the item of equipment E waits for the arrival of a packet from one of the interfaces.
Step E2: the item of equipment E compares the network address elements (source, destination and IP port numbers, for example) in order to search for a communication that is already established between it and a customer application C or a server application S.
If it finds one, it lets the packet to the application N (step E21).
Otherwise, the process proceeds to step E3.
Step E3: the item of equipment E checks if the packet is a start of a connection between a customer application C and a server application S.
If it is not, it lets the packet to its addressee via one of the interfaces (step E31).
If it is, the process proceeds to step E4.
Step E4: the item of equipment E searches in its configuration for a rule which allows it to make an interception and the presence of a new application N ready to receive the communication.
If it doesn't find one, it lets the packet to its addressee (step E31).
If it does find one, the process proceeds to step E5.
Step E5: the item of equipment E creates a point of protocol termination (TCP for example) on the application N. This creates the context required so that the next packet concerning this interception which running through step E2 finds its path to the application N via step E2/E21.

Advantageously, the method described above may be easily used in the following cases:
The setting up of active networks above an existing passive network;
The increase or decrease of the capacities of an application.
The filtering of content, parental control, anti-virus, etc.
The monitoring, tapping or tracing of a network activity.
The logging and control of access to an application.
The balancing of loads or the setting into redundance of applications.
The prioritising of services, quality of services.
The compression and/or encryption of an application;
The introduction of access tunnels;
The conversion or adaptation of formats.

In general, this setting up method may be used in all cases where an application is to be installed in proxy server mode and where more selective, more discrete or cheaper methods are preferred.

1. Method for setting up applications in an existing network by interception of communications between a customer application and a server application, said method comprising the positioning of an item of equipment at an interception point of a line of communication that is known to support all of the packet exchanges between the customer and server applications, and allowing the creation of a connection termination point on a new application by imitating the network identity of the application originally requested by the customer application.

2. Method according to claim 1, wherein it is applied to networks in which the applications have a single address, and especially IP networks where the address of an application is characterised by an IP address and a port number.

3. Method according to claim 1, wherein the item of equipment comprises means of imitating the network identity of the customer application in order to open a communication between the new application and the server application.

4. Method according to claim 3, wherein the imitation of the network identity of a customer or server application is incomplete and sufficient to satisfy the identification requirements.

5. Method according to claim 1, wherein the item of equipment comprises relay means which allow the wire to wire connection of the line to be re-established in the event of a power or command being cut (either deliberately or by a watchdog application) in order to avoid disrupting the line in the event of malfunctioning of the software or hardware.

6. Method according to claim 1, wherein the item of equipment is multiplied in order to be placed in series on the same communication line in order to produce redundancy or load sharing effects so as to improve the reliability or efficiency of the processing.

7. Method according to claim 1, wherein the decision to intercept a communication is based on a system of rules configured in the item of equipment, that the interception is not necessarily automatic or obligatory and that in the absence of a rule for the interception or decision on the item of equipment, the communication will be established normally as in the absence of the item of equipment.

8. Method according to claim 1, further comprising setting up an application “frontally” with respect to one or more other applications.

9. Method according to claim 8, comprises comprising a step consisting of balancing the load between the customer and server applications.

10. Method according to claim 1, wherein the item of equipment is designed to accommodate several applications

11. Method according to claim 1, wherein the item of equipment may be specially created, be simply a software programme operating on an existing computer with the required interface characteristics in terms of number and quality, or a simple electronic board added to an existing computer or item of equipment.

12. Method according to claim 1, wherein for the processing of each packet entering the item of equipment, said method comprising the following steps:
the transmission of the packet to a new application if the network address elements indicated in the packet correspond to the context of a communication that has already been intercepted by the equipment,
otherwise:
if the packet indicates a start of connection and that there is an internal rule of the item if equipment which allows the interception and that a new application is ready to receive the communication, then a communication context is created within the item of equipment which imitates the network identity of the service originally requested,
otherwise, the packet is transmitted to the interface corresponding to its original addressee.

13. Method according to claim 1, wherein the item of equipment has several network ports and the capacity to behave as a switch and to use all of the optimisations.

14. Method according to claim 1, wherein the method is used to modify the behaviour of an existing server application and not simply to replace it by a new application.

15. Method according to claim 1, wherein the item of equipment has the capacity of autonomously-bridging the two terminations of two connections abandoned by a new application itself without closure.

16. Method according to claim 1, wherein the item of equipment is designed to delegate the processing to other items of equipment present in the network.
